(19) United States
(12) Patent Application Publication
(10) Pub. No.: US 2002/0076009 A1
(43) Pub. Date: Jun. 20, 2002

(54) International dialing using spoken commands

(76) Inventors: Lawrence A. Denenberg, Brookline, MA (US); Erin M. Panttaja, Somerville, MA (US); Christopher M. Schmandt, Winchester, MA (US)

Correspondence Address: STAAS & HALSEY LLP, 700 11TH STREET, NW, SUITE 500, WASHINGTON, DC, 20001, US

(21) Appl. No.: 09/736,162

(22) Filed: Dec. 15, 2000

(51) Int. Cl. H04M 1/64

(52) U.S. Cl. 379/88.03; 379/88.01

(57) ABSTRACT

Speech recognition software in a telephone or telephone network recognizes a non-numeric word identifying a location, and a telephone number spoken by a user. The speech recognition grammar specifies locations and optionally constraints, such as the length, for telephone numbers in those locations. Locations may consist of countries, cities, communication network names, or any combination thereof. A database containing information about locations and telephone numbers may be used to determine whether the recognized telephone number could exist at the recognized location. Once an phone number has been identified, the user is asked to confirm the location and telephone number. If confirmed, an access code, country code or city code corresponding to the recognized location is dialed after a prefix, if needed, and is followed by the recognized telephone number. This is particularly useful for international locations to reduce the number of digits that must be recognized.

### BACKGROUND OF THE INVENTION

1. Field of the Invention

The present invention is directed to dialing telephone numbers from spoken commands and, more particularly, to making international calls based on a spoken country name.

2. Description of the Related Art

Speech recognition of digits is difficult because in many languages, most digits are only one syllable. Recognizing a digit string is also much harder if the number of digits in the string is unknown. For example, if a person in the U.S.A. dials “01” for an international telephone call, the number of digits to follow is unpredictable. In this situation, it is very difficult for a speech recognition system to correctly recognize the digits.

As disclosed in U.S. patent application Ser. No. 09/631,824, filed Aug. 3, 2000 and incorporated herein by reference, it is possible to use the natural segmentation in people's voices when speaking telephone numbers to improve speech recognition. However, this technique has limited usefulness for international dialing where individuals pause in many different places, depending on country and language of origin. In addition, international phone numbers have a larger number of digits than domestic telephone phone numbers and vary in number of digits and structural regularity, further reducing the contextual information which can aid speech recognition.

Existing systems that perform voice dialing allow users to speak a fixed-length digit string, or dial by speaking a name from a personal directory. Other uses of speech recognition in calling telephone numbers include automated directory service systems that attempt to recognize city names. A variation of an automated directory service is the system disclosed in U.S. Pat. No. 5,675,632 in which speech recognition on various parts of the utterance is performed at various levels of switching in the network. For example, when a state or region is recognized, the remaining words are routed to a regional switching center that attempts to identify the city, and if the city is recognized, a city switching center attempts to identify the name of the person being called. Another system that recognizes city names uses a neural network as described in Fanty et al., “City Name Recognition over the Telephone,” Proceedings of International Conference on Acoustics, Speech, and Signal Processing, April 1993, pages 549-552. However, there is no known system that attempts to recognize country names in conjunction with phone numbers.

### SUMMARY OF THE INVENTION

An object of the present invention is to improve recognition of spoken telephone numbers.

Another object of the present invention is to improve recognition of spoken international telephone numbers.

A further object of the present invention is to improve recognition of spoken telephone numbers which require communication network access codes.

The above objects are attained by providing a method of dialing telephone numbers, including receiving an audio signal containing a location and numbers spoken by a user; performing speech recognition on at least one portion of the audio signal using a grammar including names of locations; and dialing at least a location code followed by the numbers recognized in the audio signal. In one embodiment of the present invention, the location is a country and an international call prefix is dialed followed by the country code for the country recognized in the audio signal. The location may also include a city or other region having associated therewith an area code or an equivalent in another country, such as a city code, in which case the area code or city code is dialed after the country code, if in a foreign country. The invention is preferably used in a speaker independent speech recognition system controlled by a grammar that specifies which combinations of words may be spoken and references a database of possible telephone numbers corresponding to each name that can be recognized.

The grammar and database may be very simple, e.g., for implementation in a mobile telephone, or quite sophisticated and large. For example, the grammar may be designed to handle more than one language and the database may include the ability to determine the number of digits or specific area codes for telephone numbers in particular countries. Large databases may be used in implementations on an information services platform or in a mobile switching center where memory is less of a restriction.

These objects, together with other objects and advantages which will be subsequently apparent, reside in the details of construction and operation as more fully hereinafter described and claimed, reference being had to the accompanying drawings forming a part hereof, wherein like reference numerals refer to like parts throughout.

### BRIEF DESCRIPTION OF THE DRAWINGS

FIGS. 1 and 2 are flowcharts of methods according to the present invention.

FIG. 3 is a block diagram of an information services system that can be used to implement the present invention.

FIG. 4 is a block diagram of telephone that can be used to implement the present invention.

### DETAILED DESCRIPTION OF THE INVENTION

The present invention may be implemented in many different ways and in many different types of systems. In all cases, a system implementing the present invention receives an audio signal that includes a name of a location or communication network and numbers spoken by a user. The name and numbers may be spoken together or separately in a prompt and response format and the location itself may require more than one prompt, e.g., when a city is spoken and the system recognizes that city name can be found in more than one country or state. For example, when the system is prepared to receive instructions from the user, the user may say, “call Germany 54 90 75 60” or “call Munich Germany 907560”. When a series of prompts and responses is used to input the location and numbers, the audio signal may be stored by the system in separate files, but since the information is related it will be referred to herein as simply an audio signal.

In addition to being easier for a speech recognition system to recognize, names of countries, cities and communication networks are easier for users to remember. Also, international calling is not merely a matter of dialing country codes. If the dialing system is a mobile phone used in different countries or a call processing center that receives calls originating from different countries, different strings of digits may be required to call the same location, depending on where the call originates. It is possible for a dialing system to determine the appropriate prefix, so that a user can simply say “call Munich . . . ” regardless of whether the user is in France or Germany.

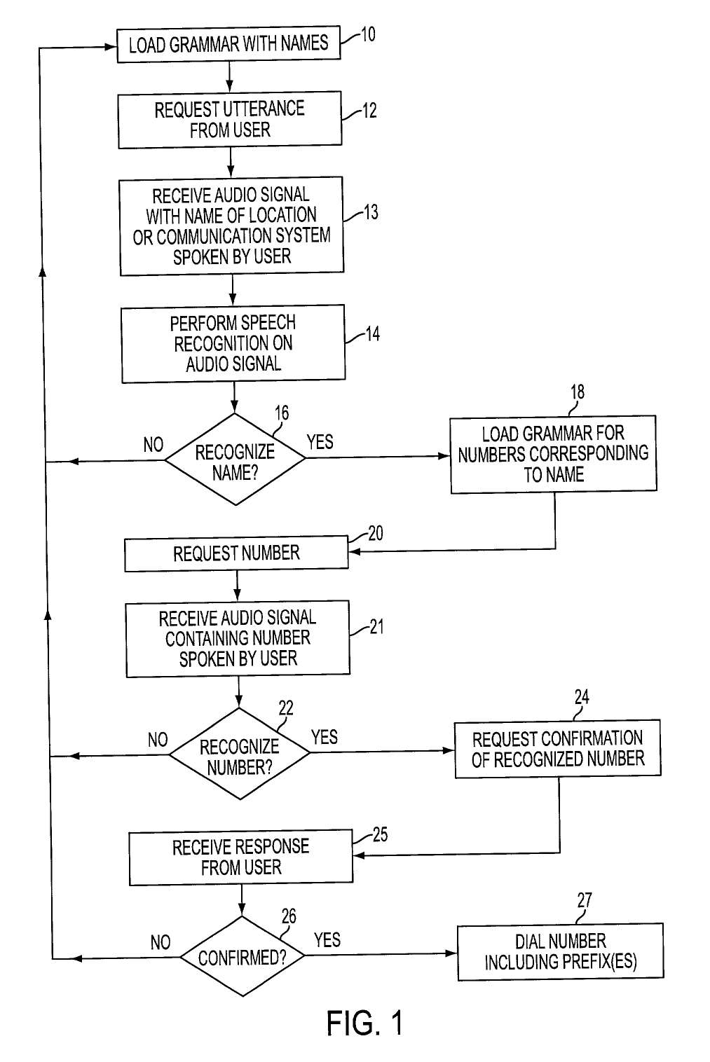

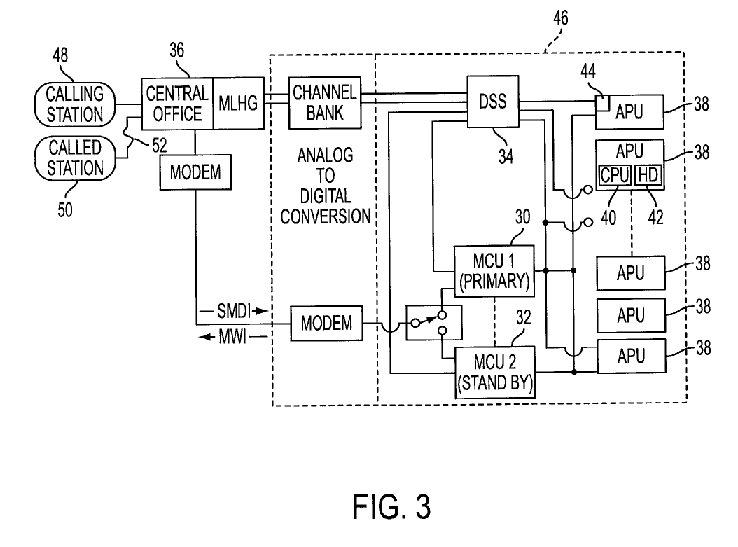

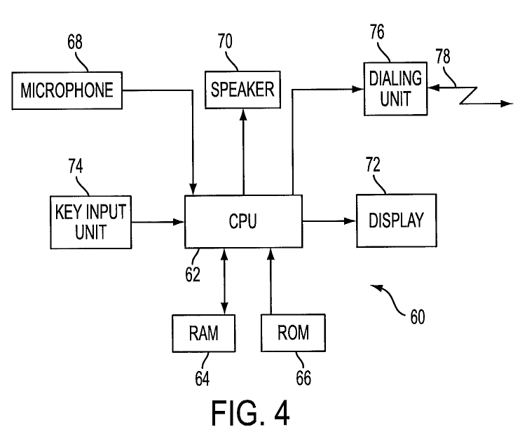

The preferred embodiment of the present invention uses a speech recognition system controlled by a grammar. Some examples of commercially available speech recognition systems that are controlled by grammars are Speechworks from Speechworks International, Inc. of Boston, Mass.; Nuance from Nuance of Menlo Park, Calif. and Philips Speech Processing available from Royal Philips Electronics N.V. in Vienna, Austria. The grammars may be stored in a database that is accessed by the program represented by the flowchart illustrated in FIG. 1. This helps provide easy scalability that is one of the benefits of the present invention. The database may be quite small and simple when implemented in a mobile telephone as described below with reference to FIG. 4, or large and sophisticated when implemented in an information services system as described below with reference to FIG. 3.

To perform international dialing according to the present invention, the grammar is generated from knowledge of international telephone systems. For example, phone numbers in Hong Kong have eight digits. Therefore one entry in a grammar that permits a user to say a country and phone number together could be “call Hong Kong <eight_digit_string>.” Some countries like Germany have phone numbers of varying length and thus, an entry in this grammar for Germany would be: call Germany <range of number of digits in a German phone number>.

An embodiment of the present invention that uses a series of prompts and responses is illustrated in FIG. 1. First, the speech recognition system is loaded 10 with a grammar that includes names of locations, i.e., countries or cities, that can be dialed, and possibly network access providers that can be used, together with a grammar, such as

call <country>

call <city><country>

call <city>

call <network>.

Next, the system requests 12 an utterance and receives 13 a response from the user. For example, the user may say “call Hong Kong.” Speech recognition is then performed 14 in an attempt to recognize 16 the word(s) spoken by the user. If the speech recognition system does not recognize 16 the words spoken by the user, the user is requested to make say something again, possibly with further instructions as conventionally used in interactive voice response systems.

If a name of a location or communication system is recognized 16, a grammar for recognizing phone numbers corresponding to the recognized name is loaded 18. The phone number grammar includes as much information as possible about the number of digits that are expected, such as eight for Hong Kong. The user is then requested 20 to speak the telephone number and the system receives 21 the response from the user. If the number is not recognized 22, the user is requested to repeat the instructions from the beginning, as illustrated in FIG. 1, or first by repeating the number.

When a match is found for both the name of the location and the telephone number, the user is requested 24 to confirm that the location and phone number have been recognized correctly. A response is received 25 from the user and if confirmed 26, a telephone is dialed 28 using the appropriate prefix, if needed, followed by the location code corresponding to the name of the location, and the numbers spoken by the user.

For example, to make the above call to Munich, Germany from the U.S.A., the system would dial “0118954 907560 ” and for a call to Washington, D.C. from Boston, the system would dial “1202” followed by a seven digit number spoken by the user. The numbers dialed may include an access code for a communication network used to make the call, in the country in which the user is located or in the country where the called party is located. The name of the communication network may be included in the audio signal with, or implying, the location, such as “Eircell” for a call to a wireless phone in Ireland. The system maps the name of the location or communication network to the access code, such as “087 ” for “Eircell ” and combines the access code with the required prefix and the recognized telephone number to dial 27 the call.

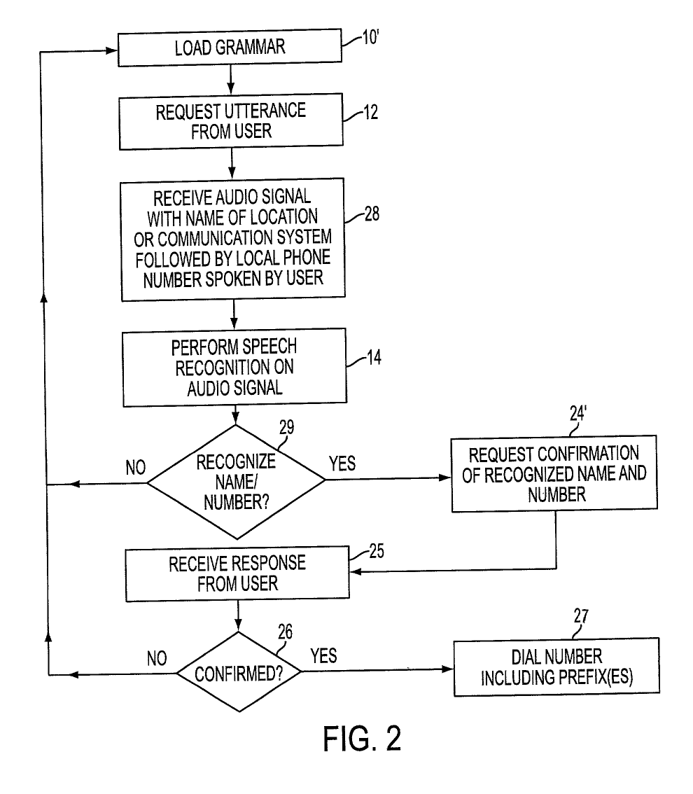

Another embodiment of the present invention is illustrated in FIG. 2 where the grammar consists of the word “call”, followed by a country name, then the number of digits required for a domestic call within that country. Thus, a grammar like the following is loaded 10′ initially.

call Hong Kong <eight_digit_string >

call Germany <range of digits in a German phone number >

call Munich, Germany <range of digits in a Munich phone number >

In this embodiment, a user says both a name and a phone number and the speech recognition system would receive 28 an audio signal with, for example, “call Hong Kong 28592111.” The system would recognize 29 the word “call,” match the country name to Hong Kong, and then recognize the eight digits required by the grammar. In this embodiment, the user would be requested to confirm 24′ the name and number together.

In any of the embodiments described above, a grammar may also allow the user to give a city name without a country name, or a communication network access code. For example in the embodiment illustrated in FIG. 1, if a user says “call Munich,” the system could provide confirmation when asking for the phone number, by producing the prompt “What is the number in Munich, Germany?” Any response by the user that is not recognized as a phone number would permit the user to try again.

One of the ways of implementing the present invention is to use an information services system, like that disclosed in U.S. Pat. No. 5,029,199, incorporated herein by reference. A block diagram of such a system is illustrated in FIG. 3 with both primary 30 and standby 32 master control units (MCUs) that control switching by a digital switching system (DSS) 34. The MCU 30 coordinates the routing of calls from a central office 36, through the DSS 34 to application processing units (APUs) 38. Each APU 38 is a computer with a processor (CPU) 40 and program and data storage (HD) 42, as well as a T1 termination which may include up to 24 voice ports or telephone interface units 44. When a user accesses information services system 46 from calling station 48 via central office 36, DSS 34 under control of MCU 30 routes the call to an APU 38 programed to perform the method illustrated in FIG. 1. After the location and telephone number are confirmed 26 (FIG. 1) by the user, information services system 46 provides call routing instructions to central office 36, so that a call can be connected through DSS 34 to called station 50 via other components (represented by jagged line 52) in the public switched telephone network (PSTN) or any other conventional communications network.

An alternative way of implementing the present invention is in a telephone that includes at least a processor, program and data storage, and conventional telephone components, such as microphone, speaker and dialing circuitry. In this case, the “system” referred to in describing the method illustrated in FIG. 1 may be either a mobile telephone or a land-line telephone and currently it is common to include a processor and at least minimal storage in both types of phones. Illustrated in FIG. 4 is a block diagram of a mobile telephone 60, as disclosed in U.S. Pat. No. 4,908,853, incorporated herein by reference. Telephone 60 includes processor (CPU) 62 which controls the remaining components and executes the method illustrated in FIG. 1. Random access memory (RAM) 64 stores data, such as the audio signal spoken by the user and may also store the grammar and the database with location codes and telephone numbers. The program executed by CPU 62, including the speech recognition software, is stored in read only memory (ROM) 66. The grammar and database may be stored in ROM 66 if not stored in RAM 64 or auxiliary storage (not shown), which may be removable memory, such as flash memory. Microphone (MIC) 68 and speaker (SPKR) 70 provide the audio interface with the user to receive the audio signal and play back the location and telephone number for user confirmation. Alternatively display 72 and key input unit 74 may be used for requesting 24 and providing 25 confirmation in the method illustrated in FIG. 1 instead of playing back the location and telephone number, and are also used for manual dialing of telephone numbers. Dialing unit 76, connected to telephone line 78 is used to dial 28 (FIG. 1) the number.

The many features and advantages of the present invention are apparent from the detailed specification, and thus it is intended by the appended claims to cover all such features and advantages of the system that fall within the true spirit and scope of the invention. Further, numerous modifications and changes will readily occur to those skilled in the art from the disclosure of this invention, thus it is not desired to limit the invention to the exact construction and operation illustrated and described. For example, a communication network provider that provides part of the public switched telephone network may implement the invention within its local, mobile or international switching offices, instead of using an information services system, or the invention could be implemented in a private branch exchange. The invention could also be implemented entirely within the telephone set, or in a separate device which attaches to a telephone set or a telephone network. Accordingly, modifications and equivalents may be resorted to as falling within the scope and spirit of the invention.

What is claimed is:

1. A method of dialing telephone numbers, comprising:
receiving an audio signal including a location and numbers spoken by a user;
performing speech recognition on at least one portion of the audio signal using a grammar including names of locations and digit strings; and
dialing at least a location code followed by the numbers recognized in the audio signal.

2. A method as recited in claim 1,
wherein the location includes a country, and
wherein said dialing dials a prefix and country code for the country recognized in the audio signal.

3. A method as recited in claim 2,
wherein the location further includes a city, and
wherein said dialing dials an area code associated with the city after the country code.

4. A method as recited in claim 1, wherein the speech recognition is speaker independent.

5. A method as recited in claim 1, further comprising determining information to assist in recognizing the numbers based on recognition of the location.

6. A method as recited in claim 5, wherein the information assisting in recognition of the numbers includes a number of digits that can follow the location code.

7. A method as recited in claim 5, wherein the information assisting in recognition of the numbers includes a table of area codes.

8. A method as recited in claim 5, wherein the information assisting in recognition of the numbers includes expected segmentation of the numbers spoken by the user.

9. A method as recited in claim 1,
wherein the audio signal further includes a communication network to access by said dialing,
wherein the grammar used in said performing further includes at least one name of a communication network, and
wherein said dialing includes dialing an access code for the communication network when recognized in the audio signal.

10. A method as recited in claim 1, further comprising mapping a recognized location to the location code used in said dialing.

11. A method as recited in claim 10, wherein said mapping uses a table including a plurality of location names mapped to the location code.

12. A method as recited in claim 1, wherein said dialing is performed by a telephone.

13. A method as recited in claim 1, wherein said dialing is performed by an information services platform.

14. A method as recited in claim 1, wherein said dialing is performed by a switching system.

15. A method as recited in claim 14, wherein said dialing is performed by a private branch exchange.

16. A method as recited in claim 14, wherein said dialing is performed by a mobile switching center.

17. A computer readable medium storing at least one program to control a processor to perform a method of dialing telephone numbers, said method comprising:
receiving an audio signal including a location and numbers spoken by a user;
performing speech recognition on at least one portion of the audio signal using a grammar including names of locations and digit strings; and
dialing at least a location code followed by the numbers recognized in the audio signal.

18. A method as recited in claim 17,
wherein the location includes a country, and
wherein said dialing dials a prefix and country code for the country recognized in the audio signal.

19. A method as recited in claim 18,
wherein the location further includes a city, and
wherein said dialing dials an area code associated with the city after the country code.

20. A method as recited in claim 17, further comprising determining information to assist in recognizing the numbers based on recognition of the location.

21. A method as recited in claim 20, wherein the information assisting in recognition of the numbers includes a number of digits that can follow the location code.

22. A method as recited in claim 17,
wherein the audio signal further includes a communication network to access by said dialing,
wherein the grammar used in said performing further includes at least one name of a communication network, and
wherein said dialing includes dialing an access code for the communication network when recognized in the audio signal.

23. A system for dialing telephone numbers, comprising:
a storage unit to store a speech recognition grammar including names of locations and numbers, a database including access codes mapped to location names, and at least one audio file including a location and numbers spoken by a user;
a processor, coupled to said storage unit, to perform speech recognition on the at least one audio file using the speech recognition grammar; and
a dialing unit, coupled to said processor, to dial a selected access code corresponding to a recognized location followed by the numbers recognized in the audio signal.

24. A system as recited in claim 23, wherein said system is a telephone.

25. A system as recited in claim 23, wherein said system is an information services platform.

26. A system as recited in claim 25, further comprising:
a master control unit to control operation of said information services system, and
a plurality of application processing units, coupled to said master control unit, each including at least one processor unit providing said processor and at least one telephone interface unit providing said dialing unit.

27. A system as recited in claim 23, wherein said system is a switching system.

28. A system as recited in claim 27, wherein said system is a private branch exchange.

29. A system as recited in claim 27, wherein said system is a mobile switching center.

30. A system for dialing telephone numbers, comprising:
means for receiving an audio signal including a location and numbers spoken by a user;
means for performing speech recognition on at least one portion of the audio signal using a grammar including names of locations and digit strings; and
means for dialing at least a location code followed by the numbers recognized in the audio signal.
